(19) United States
(12) Patent Application Publication
(10) Pub. No.: US 2007/0058594 A1
(43) Pub. Date: Mar. 15, 2007

(54) Channel allocation method between heterogeneous wireless networks and wireless network apparatus providing the same

(75) Inventors: Dae-gyu Bae, Suwon-si (KR); Jin-woo HONG, Suwon-si (KR); Hyun-ah Sung, Seoul (KR); Se-Hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/476,101

(22) Filed: Jun. 28, 2006

(30) Foreign Application Priority Data
Aug. 8, 2005 (KR) 10-2005-0072410

(51) Int. Cl. H04J 3/00

(52) U.S. Cl. 370/336; 375/343

(57) ABSTRACT

A wireless network apparatus and method for performing channel allocation between heterogeneous wireless networks is provided. The wireless network apparatus includes a first ultra wide band (UWB) interface module that transmits and receives a frame compliant with a first UWB communication format; a second UWB interface module that transmits and receives a frame compliant with a second UWB communication format; and a channel time adjustment module that generates a transmission frame having channel allocation information, which is contained in a frame received through the first UWB interface module, reflected thereon and transmits the generated transmission frame through the second UWB interface module. The method includes receiving a frame compliant with a first ultra wide band (UWB) communication format; generating a transmission frame having channel allocation information reflected thereon; and transmitting the generated transmission frame according to a second UWB communication format.

### CROSS-REFERENCE TO RELATED APPLICATION

This application claims priority from Korean Patent Application No. 10-2005-0072410 filed on Aug. 8, 2005 in the Korean Intellectual Property Office, the disclosure of which is incorporated herein by reference in its entirety.

### BACKGROUND OF THE INVENTION

1. Field of the Invention

Methods and apparatuses consistent with the present invention relate to channel allocation, and more particularly, to performing channel allocation between heterogeneous wireless networks having different formats.

2. Description of the Related Art

Recent developments in communications and network technologies have changed the network environment from wired networks using wired media such as coaxial cables or optical cables to wireless networks using signals in various frequency bands. Accordingly, mobile computing apparatuses having wireless network interface modules and performing a specific function by processing a variety of data (hereinafter referred to as “wireless networking apparatuses”) have been developed. In addition, wireless network technologies for efficient communication between wireless network apparatuses have also been introduced.

Wireless networks can be classified into two types.

One type is a wireless network comprising an access point, as illustrated in FIG. 1, which is referred to as an “infrastructure mode wireless network”, and the other type is a wireless network without an access point, as illustrated in FIG. 2, which is referred to as a “wireless network of ad-hoc mode.”

The infrastructure network contains an access point 10 as shown in FIG. 1, whereas the ad-hoc network requires no access point for communication as shown in FIG. 2.

In an infrastructure mode, an access point not only has connectivity to the wired network but also provides communication among wireless network devices within a wireless network. Thus, all data traffic in the infrastructure network is relayed through the access point.

In an ad-hoc mode, wireless network devices within a single wireless network can directly communicate with one another without using an access point.

Such wireless networks can be further classified into two types based on the presence of a coordinator. In one type of network, which is called a “coordinator-based wireless network”, a randomly selected wireless device acts as a coordinator that assigns channel time to other wireless devices within the same wireless network for data transmission, and then the other wireless devices are allowed to transmit data only at the assigned time. As compared to the coordinator-based wireless network, the other type of network allows all network devices to transmit data at any time desired without using a coordinator.

The coordinator-based wireless network is a single independent coordinator-centered network. When there are multiple coordinator-based wireless networks within a certain area, each network has a unique identifier (ID) to distinguish itself from the others.

Thus, while wireless devices can transmit/receive data to/from other network devices during a channel time assigned by the coordinator on a coordinator-based network to which they belong, they are not allowed to communicate with wireless devices belonging to another coordinator-based network.

One representative example of such former type of coordinator-based wireless devices is a wireless network device using a direct sequence ultra wide bandwidth (DS-UWB) communication format complying with the IEEE 802.15.3 standard.

On the other hand, a representative example of the latter type of coordinator-based wireless devices is a wireless network device using a multi-band orthogonal frequency division multiplexing (OFDM) Alliance Physical Layer/Media Access Control Layer (MBOA PHY/MAC) standard.

Although these two ultra wide band (UWB) wireless networks are the same in the sense that they perform communication using UWB signals, they are fundamentally different from each other, and signals sent using one of these networks would be unreadable by devices designed to use the other. Furthermore, should additional networks be introduced, it is likely that those new networks would also be incompatible with existing networks.

### SUMMARY OF THE INVENTION

The present invention provides a method for performing channel allocation in a wireless network system where heterogeneous wireless networks having different formats coexist, such that information regarding channel periods allocated to the heterogeneous wireless networks is shared by the respective heterogeneous wireless networks.

The present invention also provides an apparatus performing the channel allocation method.

According to an aspect of the present invention, there is provided a wireless network apparatus which includes a first ultra wide band (UWB) interface module that transmits and receives a frame compliant with a first UWB communication format; a second UWB interface module that transmits and receives a frame compliant with a second UWB communication format; and a channel time adjustment module that generates a transmission frame having channel allocation information, which is contained in a frame received through the first UWB interface module, reflected thereon and transmits the generated transmission frame through the second UWB interface module.

According to another aspect of the present invention, there is provided a method for performing channel allocation between heterogeneous wireless networks, the method including receiving a frame compliant with a first ultra wide band (UWB) communication format; generating a transmission frame having channel allocation information reflected thereon; and transmitting the generated transmission frame according to a second UWB communication format.

### BRIEF DESCRIPTION OF THE DRAWINGS

The above and other aspects of the present invention will become more apparent by describing in detail exemplary embodiments thereof with reference to the attached drawings in which:

FIG. 1 illustrates a related art infrastructure mode wireless network device;

FIG. 2 illustrates a related art ad-hoc mode wireless network device;

FIG. 3 is a block diagram of a wireless network device according to an exemplary embodiment of the present invention;

FIG. 4 illustrates the format of superframes according to an exemplary embodiment of the present invention;

FIG. 5 is an illustration of superframes supporting the IEEE 802.15.3 standard and the MBOA standard according to an exemplary embodiment of the present invention; and

FIG. 6 is a flowchart illustrating a method for performing channel allocation according to an exemplary embodiment of the present invention.

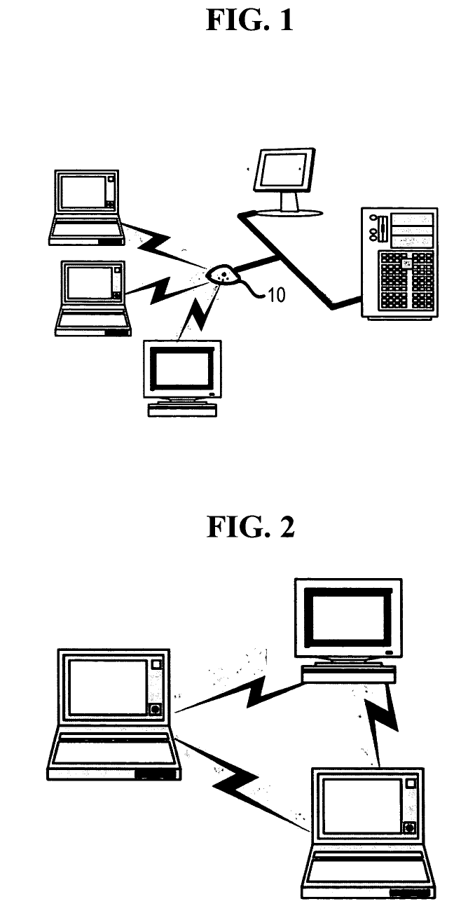

### DETAILED DESCRIPTION OF EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

For a better understanding of exemplary embodiments of the present invention, heterogeneous networks consisting of a DS-UWB wireless network compliant with the IEEE 802.15.3 standard and an MBOA wireless network compliant with the MBOA standard, will be described by way of example.

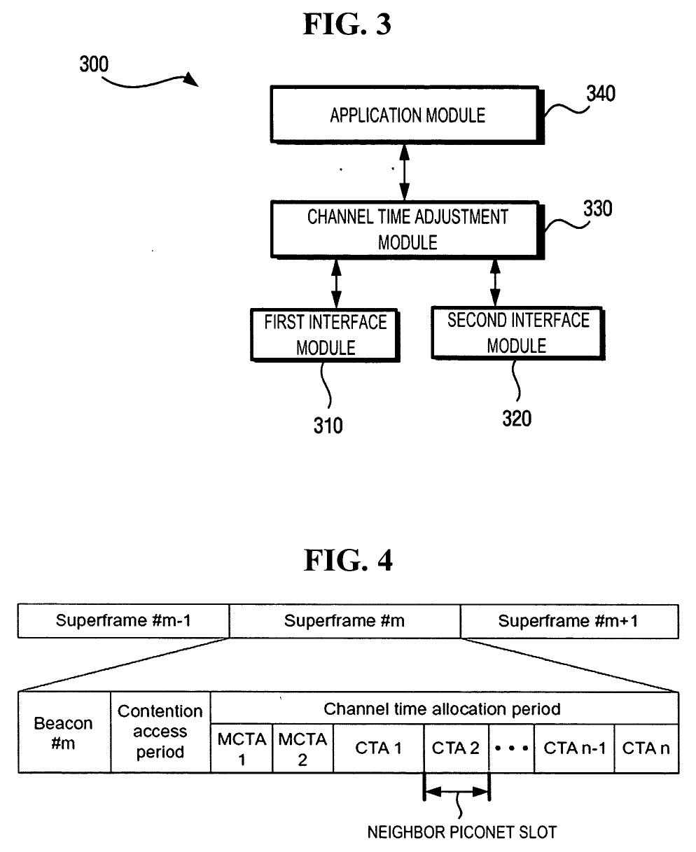

FIG. 3 is a block diagram of a wireless network device 300 according to an exemplary embodiment of the present invention.

Referring to FIG. 3, the wireless network device 300 includes a first UWB interface module 310, a second UWB interface module 320, a channel time adjustment module 330 and an application module 340.

The first UWB interface module 310, which is a module performing operations for physical (PHY) layers and media access control (MAC) layers defined in the IEEE 802.15.3 standard (hereinafter to be abbreviated as ‘the 15.3-standard’), communicates with other network apparatuses supporting the DS-UWB standard in a wireless network system in which a communication compliant with the DS-UWB standard is established.

According to the 15.3-standard based DS-UWB communication method, which is a Time Division Multiple Access (TDMA) method, when a Piconet Coordinator (PNC) broadcasts a beacon frame, devices belonging to the DS-UWB wireless network request the PNC for a Channel Time Allocation (CTA), and the PNC allocates the CTA as requested. In this regard, the 15.3-standard may be referred to. The first UWB interface module 310 generates beacon frames based on the 15.3-standard superframe and broadcasts the same so that the first UWB interface module 310 performs the same function as the PNC. In addition, the first UWB interface module 310 receives a 15.3-standard beacon frame transmitted from other wireless network apparatuses.

The second UWB interface module 320, which is a module performing operations for PHY layers and MAC layers defined in the Multi-Band OFDM Alliance (MBOA) standard, communicates with other network apparatuses supporting the MBOA standard in a wireless network system in which a communication compliant with the MBOA standard is established.

The MBOA communication method is a TDMA method, in which each device belonging to the MBOA network sets up its own Medium Access Slot (MAS) as a Distributed Reservation Protocol (DRP) to share a channel. More details are described in the MBOA Draft MAC Standard 0.95.

The second UWB interface module 320 generates beacon frames based on the superframe compliant with the MBOA standard and broadcasts the same. Alternatively, the second UWB interface module 320 may receive an MBOA beacon transmitted from other wireless network apparatuses.

The channel time adjustment module 330 adjusts each channel time using the respective beacon frames received from the first UWB interface module 310 and the second UWB interface module 320 and the superframes compliant with the 15.3-standard and the MBOA standard.

For example, if the wireless network device 300 receives a 15.3-standard beacon frame through the first UWB interface module 310, the channel time adjustment module 330 generates an MBOA beacon frame using the 15.3-standard superframe, the MBOA superframe and information contained in the received 15.3-standard beacon frame, and then broadcasts the generated MBOA beacon frame through the second UWB interface module 320, thereby enabling channel allocation for data transmission on the MBOA network.

Here, the channel time adjustment module 330 reflects channel allocation information contained in the MBOA beacon frame on the 15.3-standard beacon frame to then be broadcast through the first UWB interface module 310.

That is, the channel time adjustment module 330 generates both the 15.3-standard beacon frame and the MBOA beacon frame to then broadcast the same through the respective interface modules 310 and 320.

The application module 340 includes various application programs loaded in the wireless network device 300. To implement data communication with other wireless network apparatuses, the application module 340 requests the channel adjustment module 330 for channel allocation for data transmission.

After being requested, the channel time adjustment module 330 performs channel allocation through the first UWB interface module 310 or the second UWB interface module 320. Then, the application module 340 performs data transmission through a channel allocated thereto.

FIG. 4 illustrates the format of superframes according to an exemplary embodiment of the present invention, the superframes complying with the IEEE 802.15.3 standard. Each superframe is 65536 μs long, which is the same as the MBOA superframe.

A superframe represents a temporal structure and an MAC frame for exchanging data between devices is embodied in the superframe. Each superframe is composed of a beacon containing control information, a Contention Access Period (CAP) for transmitting data through a backoff procedure, and Channel Time Allocation Period (CTAP) for transmitting data without contention within the allocated time. Among them, CAP can be replaced by Management CTA (MCTA).

Here, competitive access can be made in an CAP through an Carrier Sense Multiple Access/Collision Avoidance (CSMA/CA) system and a channel can be accessed in MCTA through a slotted Aloha method.

CTAP can comprise a plurality of MCTA blocks and a plurality of CTA blocks. CTA is classified into two types: i.e., a dynamic CTA and a pseudo-static CTA.

The dynamic CTA can be changed in position in each superframe, but cannot be used in a relevant superframe if the beacon of a superframe is lost. On the other hand, the pseudo static CTA remains unchanged in the same fixed position, and can be used in the fixed position even if the beacon of a superframe is lost. However, the pseudo static CTA cannot be used if a beacon is continuously lost over the number of times corresponding to mMaxLostBeacons.

A method of reflecting the channel allocation information on the 15.3-standard superframe according to an exemplary embodiment as shown in FIG. 4 existing over the MBOA network will now be described.

If the second UWB interface module 320 receives an MBOA beacon frame, the channel time adjustment module 330 checks using the received MBOA beacon frame from which period channel allocation has been initiated on the MBOA network.

A slot corresponding to the allocated channel in the 15.3-standard superframe is designated as a ‘neighbor piconet’ slot. A 15.3-standard beacon frame containing information regarding the allocated channel is broadcast so that it may not be used in other 15.3-standard devices or networks.

Referring to FIG. 4, when the slot corresponding to the allocated channel is a CTA2 slot, the CTA2 slot is designated as the ‘neighbor piconet’ slot.

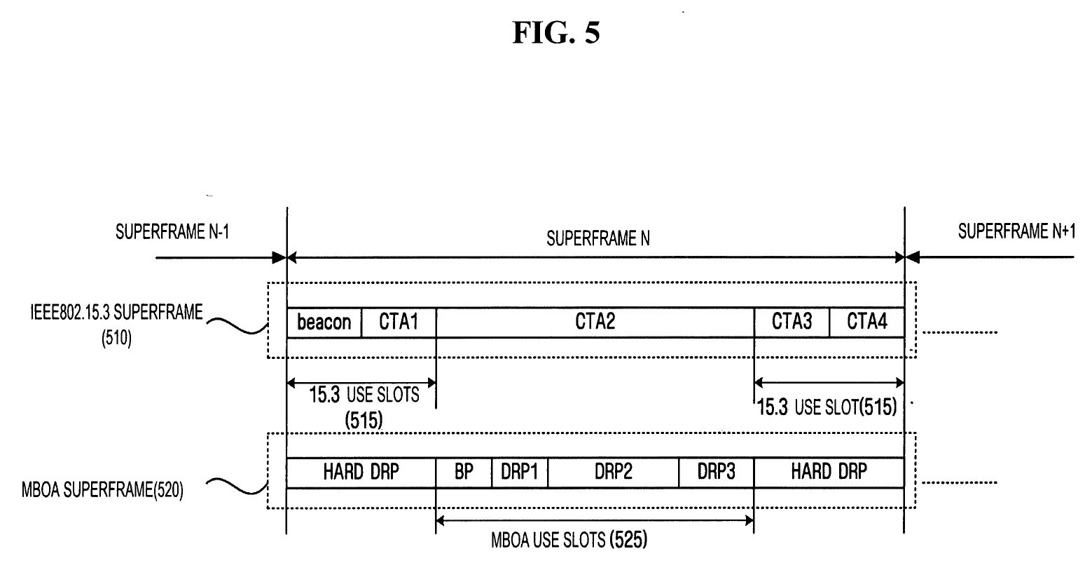

FIG. 5 is an illustration of superframes supporting the IEEE 802.15.3-standard and the MBOA standard according to an exemplary embodiment of the present invention. Information regarding channel allocation can be shared using the superframes.

As stated above, lengths of an IEEE 15.3-standard superframe 510 and an MBOA superframe 520 are the same, i.e., 65536 μs. The IEEE 15.3-standard superframe (abbreviated as 15.3-standard superframe) 510 has various slots allocated for data transmission, including beacon and CTA slots, i.e., CTA1 through CTA4, the beacon, the CTA1, CTA3 and CTA4 corresponding to 15.3-standard slots labeled as 15.3 use slots 515. The MBOA superframe 520 has various distributed reservation protocol (DRP) slots allocated for data transmission, including HARD DRP, BP, and DRP1 through DRP4. Here, BP, DRP1, DRP2 and DRP3 correspond to MBOA use slots labeled 525.

If it is detected that channels are allocated in the CTA2 slot by devices complying with the MBOA standard, the 15.3 use slots 515 of the 15.3-standard superframe 510 is designated as a neighbor piconet slot, like in FIG. 4.

Therefore, the wireless network devices compliant with the 15.3 standard are not allowed for channel allocation in the CTA2 slots but are allowed for channel allocation in 15.3 use slots 515, as illustrated in FIG. 5.

If it is detected that wireless network devices compliant with the IEEE standard are not allowed for channel allocation in the CTA2 slots but are allowed for channel allocation only in the 15.3 use slots 515 shown in FIG. 5, the slot corresponding to the MBOA superframe 520 is allocated as the ‘HARD DRP’ slot, as illustrated in FIG. 5.

Therefore, the wireless networks compliant with the MBOA standard are not allowed for channel allocation in the ‘HARD DRP’ slot but are allowed for channel allocation only in the MBOA slots 525, as illustrated in FIG. 5.

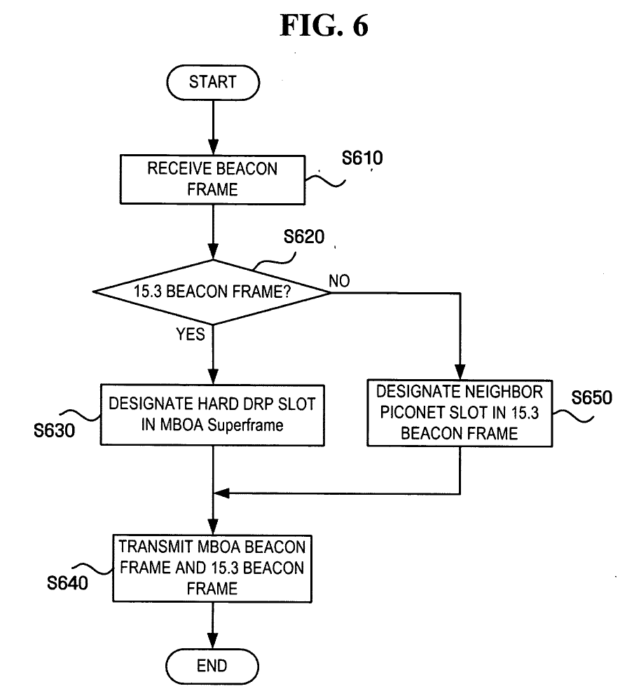

FIG. 6 is a flowchart illustrating a method for performing channel allocation between heterogeneous networks according to an exemplary embodiment of the present invention.

The wireless network apparatus 300 receives a beacon frame in operation S610. In operation S620, it is determined whether the received beacon frame is a 15.3-standard beacon frame or an MBOA beacon frame.

If the received beacon frame is a 15.3-standard beacon frame, the channel time adjustment module 330 extracts channel allocation information contained in the received beacon frame and reflects the extracted channel allocation information on an MBOA superframe, in operation S630. That is, the channel time adjustment module 330 allocates a ‘HARD DRP’ slot to the MBOA superframe so that other devices existing in the MBOA network are not allowed to use the allocated HARD DRP slot.

In operation S640, the reflected information is loaded on the MBOA beacon frame to then be transmitted through the second UWB interface module 320. At this time, the reflected information may be loaded on the 15.3-standard beacon frame to be transmitted through the first UWB interface module 310.

Here, a broadcasting method is used as a transmission method.

If it is determined in operation S620 that the received beacon frame is an MBOA beacon frame, the channel time adjustment module 330 reflects the extracted channel allocation information that is contained in the received beacon frame on the 15.3-standard superframe, in operation S650. That is to say, a neighbor piconet slot is allocated as the 15.3-standard superframe, as illustrated in FIG. 4, thereby preventing other devices existing on the 15.3-standard from using the allocated neighbor piconet slot.

As described above, according to exemplary embodiments of the present invention, in a wireless network environment in which different formats of wireless networks coexist, since information regarding channel slots allocated to heterogeneous wireless networks is shared by the respective heterogeneous wireless networks, data communication can be implemented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wireless network apparatus comprising:
a first ultra wide band (UWB) interface module that transmits and receives a frame compliant with a first UWB communication format;
a second UWB interface module that transmits and receives a frame compliant with a second UWB communication format; and
a channel time adjustment module that generates a transmission frame having channel allocation information, which is contained in a frame received through the first UWB interface module, reflected thereon and transmits the generated transmission frame through the second UWB interface module.

2. The wireless network apparatus of claim 1, wherein the first UWB communication format is a direct sequence ultrawide bandwidth (DS-UWB) communication format compliant with the IEEE 802.15.3 standard.

3. The wireless network apparatus of claim 2, wherein, the second UWB communication format is a wireless network using multi-band OFDM Alliance Physical Layer/Media Access Control Layer (MBOA PHY/MAC) standard.

4. The wireless network apparatus of claim 3, wherein the frame received through the first UWB interface module includes a beacon frame compliant with the IEEE 803.15.3 standard.

5. The wireless network apparatus of claim 3, wherein the transmission frame includes a beacon frame compliant with a multi-band OFDM Alliance (MBOA) standard.

6. The wireless network apparatus of claim 3, wherein the channel adjustment module designates a slot corresponding to an allocated channel in the frame received through the first UWB interface module as a specific slot so that devices operated using the second UWB communication format are not allowed channel allocation in the specific slot.

7. The wireless network apparatus of claim 6, wherein the specific slot that is designated by the channel adjustment module is a HARD DRP slot.

8. The wireless network apparatus of claim 1, wherein the first UWB communication format is a multi-band OFDM Alliance (MBOA) communication format compliant with the MBOA standard.

9. The wireless network apparatus of claim 8, wherein the second UWB communication format is a direct sequence (DS)-UWB communication format compliant with the IEEE 803.15.3 standard.

10. The wireless network apparatus of claim 9, wherein the frame received through the first UWB interface module includes a beacon frame compliant with the MBOA standard.

11. The wireless network apparatus of claim 9, wherein the transmission frame includes a beacon frame compliant with the IEEE 803.15.3 standard.

12. The wireless network apparatus of claim 8, wherein the channel adjustment module designates a slot corresponding to an allocated channel in the frame received through the first UWB interface module as a specific slot so that devices operated using the second UWB communication format are not allowed channel allocation in the specific slot.

13. The wireless network apparatus of claim 12, wherein the specific slot that is designated by the channel adjustment module is a neighbor piconet slot.

14. A method for performing channel allocation between heterogeneous wireless networks, the method comprising:
receiving a frame compliant with a first ultra wide band (UWB) communication format;
generating a transmission frame having channel allocation information reflected thereon; and
transmitting the generated transmission frame according to a second UWB communication format.

15. The method of claim 14, wherein the first UWB communication format is a direct sequence (DS)-UWB communication format compliant with the IEEE 802.15.3 standard.

16. The method of claim 15, wherein the second UWB communication format is a multi-band OFDM Alliance (MBOA) communication format compliant with the MBOA standard.

17. The method of claim 16, wherein the frame is a beacon frame compliant with the IEEE 803.15.3 standard.

18. The method of claim 16, wherein the transmission frame includes a beacon frame compliant with a multi-band OFDM Alliance (MBOA) standard.

19. The method of claim 16, wherein the transmitting of the generated transmission frame comprises designating a slot corresponding to an allocated channel in the frame received through the first UWB interface module as a specific slot so that devices operated using the second UWB communication format are not allowed channel allocation in the specific slot.

20. The method of claim 19, wherein the specific slot that is designated is a HARD DRP slot.

21. The method of claim 14, wherein the first UWB communication format is an MBOA communication format compliant with the MBOA standard.

22. The method of claim 21, wherein the second UWB communication format is a DS-UWB communication format compliant with the IEEE 802.15.3 standard.

23. The method of claim 22, wherein the frame is a beacon frame compliant with a multi-band OFDM Alliance (MBOA) standard.

24. The method of claim 22, wherein the transmission frame is a beacon frame compliant with the IEEE 802.15.3 standard.

25. The method of claim 22, wherein the transmitting of the generated transmission frame comprises designating a slot corresponding to an allocated channel in the frame received through the first UWB interface module as a specific slot so that devices operated using the second UWB communication format are not allowed channel allocation in the specific slot.

26. The method of claim 25, wherein the specific slot that is designated is a neighbor piconet slot.
